(19) United States
(12) Patent Application Publication
(10) Pub. No.: US 2026/0351944 A1
(43) Pub. Date: Nov. 5, 2026

(54) BUSWAY AND HOUSING THEREOF, AND BUSWAY ASSEMBLY

(71) Applicant: Schneider Electric Industries SAS, Rueil Maimaison (FR)

(72) Inventors: Lilong SHI, Guangzhou (CN); Jianliang Huang, Guangzhou (CN)

(21) Appl. No.: 19/242,612

(22) Filed: Jun. 18, 2025

(30) Foreign Application Priority Data
Apr. 30, 2025 (CN) 202520865034.0

(51) Int. Cl. H02G 5/06

(52) U.S. Cl. CPC H02G 5/06

(57) ABSTRACT

Embodiments of the disclosure provide a busway and a housing thereof, and a busway assembly. The housing of the busway includes: a first top plate and a first bottom plate; a first side plate and a second side plate; and a plurality of partitions dividing an inner cavity of the first housing into a plurality of mounting cavities, where the first bottom plate is provided with a plurality of openings, and the plurality of mounting cavities are communicated with the exterior through the plurality of openings. The second housing located outside the first housing and including a second top plate and a third side plate, the second top plate being connected to the first top plate through at least one first rib plate, and the third side plate being connected to one of the first side plate and the second side plate through at least one second rib plate.

### CROSS-REFERENCE

This application claims priority to Chinese Patent Application No. 202520865034.0, filed on Apr. 30, 2025, and entitled “BUSWAY AND HOUSING THEREOF”, the entirety of which is incorporated herein by reference.

### FIELD

Embodiments of the present disclosure generally relate to the technical field of electrical equipment, and in particular, to a busway and a housing thereof, and a busway assembly.

### BACKGROUND

Busway is a transmission facility of a high-current power supply line and has wide application in electrical equipment and power systems of civil buildings, factories and the like. The busway includes a housing and a set of conductors. The set of conductors includes a plurality of conductors, a plurality of mounting cavities are formed in the housing, and the plurality of conductors are respectively mounted in the corresponding mounting cavities. The conductors used to form current loop are insulated from the housing. A busway used in a three-phase, four-wire power supply system includes four mounting cavities and four conductors, the four conductors include an A phase, a B phase and a C phase as phase lines and an N line as a neutral line, where the A phase, the B phase and the C phase are located on a side of the N line. Compared with the busway used in the three-phase, four-wire power supply system, a busway used in a three-phase, five-wire power supply system has an additional mounting cavity in the housing, and the plurality of conductors further have an PE line as a ground wire, and the PE line is located on the other side of the N line.

### SUMMARY

In a first aspect of the present disclosure, a housing of a busway is provided and includes a first housing and a second housing located outside the first housing. The first housing includes: a first top plate and a first bottom plate opposite to each other; a first side plate and a second side plate opposite to each other; and a plurality of partitions respectively connected to the first top plate and the first bottom plate and spaced apart in a direction from the first side plate to the second side plate, the plurality of partitions dividing an inner cavity of the first housing into a plurality of mounting cavities for accommodating a plurality of conductors, where the first bottom plate is provided with a plurality of openings, and the plurality of mounting cavities are communicated with the exterior through the plurality of openings. The second housing located outside the first housing and at least including a second top plate and a third side plate connected to each other, the second top plate being connected to the first top plate through at least one first rib plate, and the third side plate being connected to one of the first side plate and the second side plate through at least one second rib plate.

In some embodiments, the third side plate is connected to the first side plate through the at least one second rib plate, and a junction of the first top plate and the first side plate is connected to a junction of the second top plate and the third side plate through a third rib plate.

In some embodiments, the plurality of mounting cavities include three phase line mounting cavities and one neutral line mounting cavity sequentially arranged in the direction from the first side plate to the second side plate, and the third side plate is connected to the first side plate through the at least one second rib plate.

In some embodiments, the second top plate is connected to the first top plate through a plurality of first rib plates spaced apart from each other; and/or the third side plate is connected to the first side plate through a plurality of second rib plates spaced apart from each other.

In some embodiments, the plurality of mounting cavities further includes a ground wire mounting cavity located on a side of the neutral line mounting cavity facing away from the three phase line mounting cavities; and/or the first bottom plate extends from the first side plate to the third side plate, and an upper edge of the second side plate extends upward to be connected to a side edge of the second top plate close to the second side plate.

In some embodiments, the housing is provided with a mounting hole configured to be connected to a busway connector through a first fastener.

In some embodiments, two sides of a bottom of the housing are respectively provided with a engaging portion, and the engaging portion protrudes downward relative to the first bottom plate and adapted to be detachably connected to an enclosure plate, and a bottom surface of the engaging portion is provided with the mounting hole.

In some embodiments, the third side plate is adjacent to the first side plate, a first support platform is formed at a bottom of the third side plate, and a second support platform is formed at a bottom of the second side plate; and/or the second side plate and the third side plate are each provided with a third bent plate, a first accommodating groove is formed between the second side plate and a corresponding third bent plate, and a second accommodating groove is formed between the third side plate and a corresponding third bent plate.

In some embodiments, the housing is an aluminum housing.

In a second aspect of the present disclosure, a busway is provided and includes the housing of the busway according to the first aspect of the present disclosure.

In some embodiments, the busway further includes: an enclosure plate disposed at a bottom of the housing of the busway to shield the plurality of openings, a first end of the enclosure plate corresponding to a first end of the housing of the busway; a plurality of conductors disposed in the plurality of mounting cavities; a stopper covering the first end of the housing of the busway, and including a plurality of guiding grooves through which the first ends of the plurality of conductors pass, a positioning groove being formed on a wall body between each two adjacent guiding grooves, the positioning groove being adapted to be engaged with an interphase partition of a busway connector, and the stopper including a second bottom plate closing bottoms of the plurality of guiding grooves, and the second bottom plate abutting against the first end of the enclosure plate.

In some embodiments, a first end of the housing of the busway protrudes a predetermined distance relative to the first end of the enclosure plate, the second bottom plate includes an extension portion extending to the bottom of the housing of the busway to abut against the enclosure plate.

In some embodiments, the stopper includes: an end cap portion connected to the first end of housing of the busway by a second fastener, an extension direction of the second fastener being parallel to an extension direction of the plurality of guiding grooves; and a protrusion portion extending from the end cap portion in a direction away from the housing of the busway, where the second bottom plate is located at bottoms of the end cap portion and the protrusion portion, the plurality of guiding grooves penetrate through the end cap portion and the protrusion portion, each of the plurality of guiding grooves is a circumferentially closed groove, and the positioning groove is located on the protrusion portion.

In some embodiments, at least a portion of the plurality of mounting cavities is provided with an insulating member configured to insulate a corresponding conductor from the housing of the busway, and the insulating member extends from the first end of the housing of the busway and is inserted into a corresponding guiding groove.

In some embodiments, a top of each of the plurality of conductors is provided with an engaging groove, and a wall body of each of the plurality of guiding grooves is provided with an engaging protrusion configured to be engaged with the engaging groove; and/or a top of the end cap portion is provided with a connecting arm, an extending direction of the connecting arm is parallel to an extending direction of the plurality of guiding grooves, the connecting arm is connected to the housing of the busway through a third fastener, and an extending direction of the third fastener is perpendicular to the extending direction of the plurality of guiding grooves.

In a third aspect of the present disclosure, a busway assembly is provided and includes: the busway according to the second aspect of the present disclosure; and a busway connector, including: an upper cover plate and a lower cover plate assembled together, the upper cover plate and the lower cover plate defining an internal chamber and an opening communicating with the internal chamber, a first end of the busway extending into the internal chamber through the opening; and a plurality of interphase partitions located in the internal chamber, each of the interphase partitions being provided with a conductive bar, where an accommodating space is formed between each two adjacent interphase partitions, and the accommodating space is configured to accommodate a corresponding conductor of the busway.

In some embodiments, a first end of the housing of the busway protrudes a predetermined distance relative to the first end of the enclosure plate, the second bottom plate includes an extension portion extending to the bottom of the housing of the busway to abut against the enclosure plate.

In some embodiments, the lower cover plate includes a bottom wall located below the second bottom plate, and the bottom wall of the lower cover plate is provided with a upward-protruding bump, and the bump abuts against the second bottom plate.

In some embodiments, a sealing gasket is provided between the bump and the second bottom plate.

In some embodiments, the bottom wall of the lower cover plate forms an upward-extending flange at the opening, and the bottom wall of the lower cover plate is further provided with a through hole located between the flange and the bump.

The housing of the busway according to embodiments of the present disclosure has a second housing in addition to a first housing, and the second housing is connected to the first housing through rib plates, so that the rigidity and the structural strength of the first housing can be effectively enhanced, and therefore, the capability of the busway 100 to bear the short-circuit current and the service life of the busway can be improved.

It should be understood that content described in this content section is not intended to limit key features or important features of embodiments of the present disclosure, nor is it intended to limit the scope of the present disclosure. Other features of the present disclosure will be readily understood from the following description.

### BRIEF DESCRIPTION OF DRAWINGS

The above and other features, advantages, and aspects of embodiments of the present disclosure will become more apparent with reference to the following detailed description taken in conjunction with the accompanying drawings. In the drawings, the same or similar reference numbers refer to the same or similar elements, wherein:

FIG. 1 shows a cross-sectional view of a busway according to an embodiment of the present disclosure;

FIG. 2 shows a cross-sectional view of a busway according to another embodiment of the present disclosure and a busway connector connected to the busway;

FIG. 3 shows a perspective view of a busway according to a further embodiment of the present disclosure;

FIGS. 4 and 5 show perspective views of a stoper of the busway in FIG. 3 from different viewpoints;

FIGS. 6 to 8 show the installation process of the stoper of the busway in FIG. 3; and

FIG. 9 shows a cross-sectional view of a busway assembly according to an embodiment of the present disclosure.

### DETAILED DESCRIPTION

Preferred embodiments of the present disclosure will be described in more detail below with reference to the accompanying drawings. Although preferred embodiments of the present disclosure are shown in the drawings, it should be understood that the present disclosure may be implemented in various forms and should not be limited by the embodiments set forth herein. Rather, these embodiments are provided to make the present disclosure more thorough and complete, and can fully convey the scope of the present disclosure to those skilled in the art.

As used herein, the term “comprising” and variations thereof means open inclusive, i.e., “including but not limited to”. Unless specifically stated, the term “or” means “and/or”. The term “based on” means “based at least in part on”. The terms “an example embodiment” and “an embodiment” mean “at least one example embodiment”. The term “another embodiment” means “at least one further embodiment”. The terms “first”, “second”, and the like may refer to different or identical objects.

Three phase lines (A phase, B phase and C phase) of busway used in a three-phase, four-wire system or three-phase, five-wire system power supply system are arranged side by side on a side of a neutral line (N phase). In order to make the busway have good heat dissipation performance and lighter mass, a housing of the conventional busway employs a single-layer aluminum housing. When a transmission line connected to a busway fails, a short-circuit current flows through the line to the busway. When the busway bears the short-circuit current, due to the electrical connection relationship between the three phase lines, the short-circuit current will be redistributed among phase lines, so that each of the phase lines bears the short-circuit current. In addition, because the short-circuit current borne by the busway far exceeds the normal working current, a relatively large short-circuit current causes relatively large electrodynamic force to be generated between current-carrying conductors in the busway, and then the relatively large electrodynamic force is transmitted to the housing of the busway, which may cause deformation of the housing. If the housing is severely deformed, normal operation of the busway will be affected, and electrical performance and reliability thereof will be reduced.

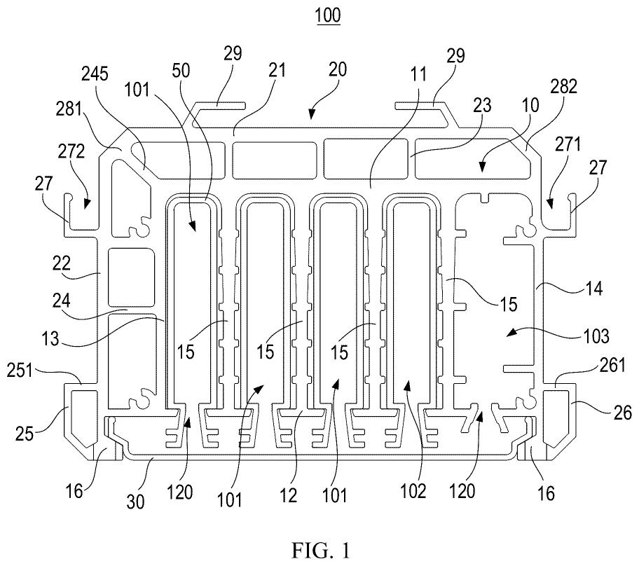

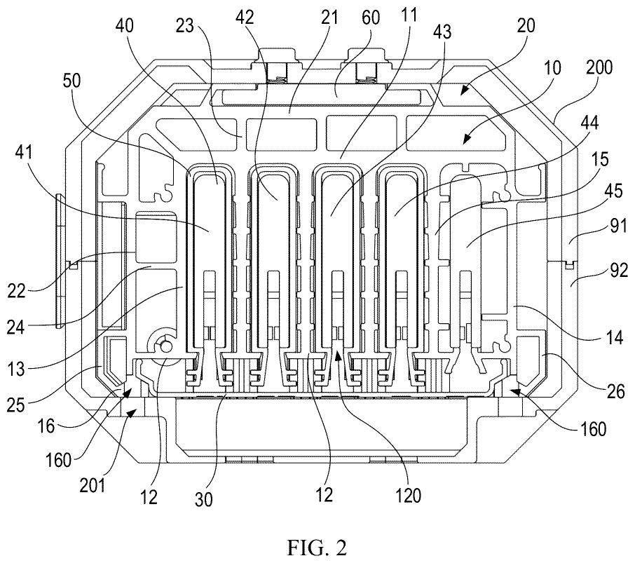

In order to solve the above problems, embodiments of the present disclosure provide a busway 100 and a housing thereof, and the housing may have a relatively strong rigidity and a relatively good structural strength even if an aluminum housing is employed, so that the housing of the busway 100 will not be excessively deformed while the busway 100 bears a large short-circuit current, thereby improving the capability of the busway 100 to bear the short-circuit current, improving the electrical performance and reliability of the busway, and prolonging the service life of the busway 100. Hereinafter, the principles of the busway 100 and the housing thereof provided by the embodiments of the present disclosure will be described in conjunction with FIG. 1 and FIG. 2.

FIG. 1 shows a cross-sectional view of a housing of a busway 100 according to an embodiment of the present disclosure. FIG. 2 shows a cross-sectional view of a busway 100 according to another embodiment of the present disclosure and a busway connector 200 connected to the busway 100. The housings of busways 100 shown in FIG. 1 and FIG. 2 are suitable for use in busways for three-phase, five-wire power supply systems. Without special description, the housing structures of the busways 100 of FIG. 1 and FIG. 2 are substantially the same, the housing structure of the busway 100 shown in FIG. 1 is substantially the same as the housing structure of the busway 100 shown in FIG. 2, and the difference between the two will be described below. The plurality of conductors 40 in the busway 100 shown in FIG. 2 are also suitable for use in busways employing the housing of the busway 100 shown in FIG. 1.

Referring to FIG. 1 and FIG. 2, the housings (not numbered in FIG. 1 and FIG. 2) of busways 100 each include a first housing 10 and a second housing 20. The first housing 10 includes a first top plate 11, a first bottom plate 12, a first side plate 13 and a second side plate 14, and a plurality of partitions 15. The first top plate 11 and the first bottom plate 12 are opposite to each other, and the first side plate 13 and the second side plate 14 are opposite to each other. The first top plate 11, the first bottom plate 12, the first side plate 13, and the second side plate 14 define an inner cavity of the first housing 10. Each of the partitions 15 is connected to the first top plate 11 and the first bottom plate 12 respectively. The plurality of partitions 15 are spaced apart in a direction from the first side plate 13 to the second side plate 14. The plurality of partitions 15 divide the inner cavity of the first housing 10 into a plurality of mounting cavities for accommodating the plurality of conductors 40.

The plurality of conductors 40 includes three phase line conductors (specifically, A phase line 41, B phase line 42, and C phase line 43), one neutral line conductor (N line conductor 44), and one ground wire conductor (PE line conductor 45), respectively. The plurality of conductors 40 are arranged side by side, the three phase line conductors are located on a side of the N line conductor 44, and the PE line conductor 45 is located on the other side of the N line conductor 44. Correspondingly, the plurality of mounting cavities include three phase line mounting cavities 101, one neutral line mounting cavity 102, and one ground wire mounting cavity 103 sequentially arranged in a direction from the first side plate 13 to the second side plate 14. The A phase line 41, the B phase line 42 and the C phase line 43 are mounted in three phase line mounting cavities 101, respectively, the N line conductor 44 is mounted in neutral line mounting cavity 102, and the PE line conductor 45 is mounted in ground wire mounting cavity 103. The A phase line 41 is adjacent to the first side plate 13 and the PE line conductor 45 is adjacent to the second side plate 14.

When the busway 100 works, current flows through the A phase line 41, the B phase line 42, the C phase line 43, and the N line conductor 44, and therefore the A phase line 41, the B phase line 42, the C phase line 43, and the N line conductor 44 may be collectively referred to as current-carrying conductors.

Referring to FIG. 1 and FIG. 2, insulating members 50 are respectively provided in the three mounting cavities 101 and the mounting cavity 102 for accommodating the current-carrying conductors, and the insulating members 50 are configured to insulate the corresponding current-carrying conductors from the housing. The insulating member 50 may be an insulating coating or an insulating plastic member. The PE line conductor 45 is in direct contact with the first housing 10 in the ground wire mounting cavity 103 to ground the first housing 10. The first bottom plate 12 is provided with a plurality of openings 120, and each of the mounting cavities communicates with the exterior through a corresponding opening 120, so that a power take-off device (for example, a plug-in box) extends into each mounting cavity to be connected to a corresponding conductor 40.

In some embodiments, each of the insulating members 50 has a flared structure protruding from the corresponding opening 120, and the flared structure helps to ensure a creepage distance between different current-carrying conductors on one hand, and helps to guide each pin of the power take-off device to be inserted into each corresponding mounting cavity to connect with the corresponding current-carrying conductor on the other hand. In some embodiments, the first bottom plate 12 may be directly formed with a flared structure at the opening 120 of the ground wire mounting cavity 103 to guide the corresponding pin of the power take-off device to be inserted into the ground wire mounting cavity 103 to be connected to the PE line conductor 45.

When the busway 100 bears a short-circuit current, the electrodynamic force between the A phase line 41 and the B phase line 42 has a greater influence on the first housing 10, so that a side of the first top plate 11 adjacent to the first side plate 13 is more prone to upward bending deformation.

Referring to FIG. 1, the second housing 20 is located outside the first housing 10 and at least includes a second top plate 21 and a third side plate 22 connected to each other, the second top plate 21 is located above the first top plate 11, and the third side plate 22 is adjacent to one of the first side plate 13 and the second side plate 14. The second housing 20 is connected to the first housing 10 through a rib plate to enhance the rigidity and structural strength of the first housing 10 and improve the deformation resistance of the first housing 10.

It can be seen from the above that the side of the first top plate 11 adjacent to the first side plate 13 is more prone to upward bending deformation, and the third side plate 22 may be specifically adjacent to the first side plate 13. The second top plate 21 is connected to the first top plate 11 through at least one first rib plate 23, and the third side plate 22 is connected to the first side plate 13 through at least one second rib plate 24.

The housing of the busway 100 according to embodiments of the present disclosure has the second housing 20 in addition to the first housing 10, and the second housing 20 is connected to the first top plate 11 and the first side plate 13 of the first housing 10 through rib plates, so that the rigidity and the structural strength of the first housing 10 can be effectively enhanced, especially the rigidity and the structural strength of the easily deformable region of the first top plate 11 can be enhanced. In this way, even if the housing is an aluminum housing, when the busway 100 bears a large short-circuit current, a double-layer hollow shape including the first housing 10 and the second housing 20 can ensure that the housing has good rigidity and structural strength, avoiding local excessive deformation of the housing. Therefore, the capability of the busway 100 to bear the short-circuit current and service life of the busway 100 are improved.

Compared with the way that the rigidity of the first housing 10 is enhanced by increasing the wall thickness of the first top plate 11 and the first side plate 13 of the first housing 10, the housing in the embodiments of the present disclosure has lighter weight and lower material cost due to the double-layer hollow shape. In addition, the housing in the embodiments of the present disclosure has a large heat dissipation area, and heat of each of the current-carrying conductors may be dissipated through the first housing 10, the first rib plate 23, the second rib plate 24, and the second housing 20, which is beneficial to improving heat dissipation performance of the busway 100.

Referring to FIG. 1 and FIG. 2, the number of both the first rib 23 and the second rib 24 is, example, not less than two. In some embodiments, the second top plate 21 is connected to the first top plate 11 through a plurality of first rib plates 23, and the plurality of first rib plates 23 are spaced apart from each other. The plurality of first ribs 23 may be evenly spaced between the first top plate 11 and the second top plate 21 or may be unevenly spaced as needed. In this embodiment, each of the first rib plates 23 is in a straight plate shape, in some alternative embodiments, each of the first rib plates 23 may be in other suitable shape as needed. Each of the first ribs 23 has a certain area and thickness. It can be understood that the shapes and sizes of any two first rib plates 23 may be the same or different.

In some embodiments, the third side plate 22 is connected to the first side plate 13 through a plurality of second rib plates 24, and the plurality of second rib plates 24 are spaced apart from each other. The plurality of second ribs 24 may be evenly spaced between the third side plate 22 and the first side plate 13 or may be unevenly spaced as needed. Each of the second ribs 24 may be in a straight plate shape or in other suitable shape. Each of the second rib plate 24 has a certain area and thickness, and it can be understood that the shapes and sizes of any two second rib plates 24 may be the same or different.

By designing the shape, size, connection position and the like of each of the first rib plates 23 and each of the second rib plate 24, the rigidity and structural strength of the entire housing (especially the easily deformable region of the first housing 10) can be significantly enhanced while controlling the weight of the entire housing and meeting other functional requirements.

In some embodiments, a junction of the second top plate 21 and the third side plate 22 may form a bevel structure 281. In some embodiments, the junction of the second top plate 21 and the third side plate 2 2 may form an arc structure, a right-angle structure, or other suitable structure. The junction of the second top plate 21 and the third side plate 22 is connected to a junction of the first top plate 11 and the first side plate 13 through a third rib plate 245, and the third rib plate 245 can enhance rigidity and structural strength of the entire housing in the easily deformable region.

In some embodiments, the first bottom plate 12 extends from the first side plate 13 to the third side plate 22 such that the first bottom plate 12 is connected to the third side plate 22. An upper edge of the second side plate 14 extends upward to be connected to a side edge of the second top plate 21 close to the second side plate 14 such that the second side plate 14 is connected to the second top plate 21. In this way, the rigidity and structural strength of the housing are further enhanced. In some embodiments, the upper edge of the second side plate 14 and the second top plate 21 may be directly connected and may form a right angle. In some embodiments, a junction between the upper edge of the second side plate 14 and the side edge of the second top plate 21 may form a bevel structure 282, an arc structure, a right-angle structure, or other suitable structure.

Referring to FIG. 1 and FIG. 2, in some embodiments, the busway 100 may further include an enclosure plate 30. Two sides of a bottom of the housing of the busway 100 are respectively provided with an engaging portion 16, the engaging portion 16 protrudes downward relative to the first bottom plate 12, and the engaging portion 16 is configured to be detachably connected to the enclosure plate 30. In some embodiments, two engaging portions 16 are obtained by respectively extending downward from two sides of the first bottom plate 12. In some embodiments, the two engaging portions 16 may be obtained by extending downward directly from the third side plate 22 and the second side plate 14. For a busway 100 that does not need to be connected to a power take-off device, the enclosure plate 30 may serve to isolate each of the conductors 40 from the exterior. For a busway 100 that needs to be connected to a power take-off device, the enclosure plate 30 can be removed from the busway 100, so that a pin of the power take-off device is allowed to be connected to each conductor 40.

Referring to FIG. 1 and FIG. 2, in some embodiments, a first support platform 251 is formed at a bottom of the third side plate 22, and a second support platform 261 is formed at a bottom of the second side plate 14. For example, the third side plate 22 may be connected to a bottom surface of an adjacent engaging portion 16 through a first bent plate 25, and the first supporting platform 251 is formed on the first bent plate 25. The second side plate 14 may be connected to a bottom surface of an adjacent engaging portion 16 through a second bent plate 26, and a second supporting platform 261 is formed on the second bent plate 26. The first support table 251 and the second support table 261 are configured to be engaged with hooks of the power take-off device to allow the power take-off device to be hung below the busway 100.

Referring to FIG. 2, in some embodiments, when the busway 100 and the busway connector 200 are connected, the engaging portions 16 are supported by a supporting portion of the busway connector 200. The first bent plate 25 and the second bent plate 26 enhance the rigidity of each of the engaging portions 16.

With continued reference to FIG. 2, in some embodiments, bottom surfaces of the engaging portions 16 may further be provided with mounting holes 160, and the mounting holes 160 are close to an end of the busway 100. When the end of the busway 100 is connected to the busway connector 200, the end of the busway 100 can be inserted into the busway connector 200. A housing of the busway connector 200 has holes 201 located below the mounting holes 160, and first fasteners (such as screws), which are not shown, are connected to the mounting holes 160 through the holes 201, which facilitates improving the connection strength and overall rigidity of the busway 100 and the busway connector 200, and improving the stress distribution between the busway 100 and the busway connector 200. In some alternative embodiments, the mounting holes 160 may be provided in any suitable positions of the housing of the busway to be connected to the busway connector 200 by means of the first fasteners, so as to improve the connection strength and the overall rigidity, and improve the stress distribution.

Referring to FIG. 1 and FIG. 2, in some embodiments, each of the second side plate 14 and the third side plate 22 is provided with a third bent plate 27, a first accommodating groove 271 is formed between the second side plate 14 and a corresponding third bent plate 27, and a second accommodating groove 272 is formed between the third side plate 22 and a corresponding third bent plate 27. The first accommodating groove 271 and the second accommodating groove 272 may accommodate a cable (e.g., a temperature measurement cable) outside the busway therein.

In some embodiments, a pair of bent plates 29 are disposed on the second top plate 21, and the pair of bent plates 20 can accommodate a connecting plate 60 through which the busway can be connected to the hanging mechanism or connected to the busway connector 200 by screws.

It should be noted that although the above embodiments are described by taking the housing being that of the three-phase, five-wire busway 100 as an example, in some alternative embodiments, a housing provided with the first housing 10 and the second housing 20 may also be applied to a three-phase, four-wire busway. For the housing applied to the three-phase, four-wire busway, since the busway is not provided with a PE line conductor, the housing correspondingly omits a mounting cavity for mounting a PE line, and thus the N line conductor 44 is adjacent to the second side plate 14.

In addition, in some embodiments not shown, the second housing 20 may further include a fourth side plate adjacent to the second side plate 14, and the fourth side plate may be connected to the second side plate 14 through one or more fourth rib plates, to further enhance rigidity and structural strength of the housing.

The housing of the busway according to embodiments of the present disclosure may be integrally formed by an extrusion process.

In the busway and the housing thereof according to the embodiments of the present disclosure, the second housing is arranged outside the first housing, and the second housing covers the easily deformable region of the first housing and is connected to the first housing through the rib plates, so that the rigidity and the structural strength of the easily deformable region of the housing of the busway can be effectively improved, avoiding local excessive deformation of the housing. Therefore, the capability of the busway 100 to bear the short-circuit current and service life of the busway 100 are improved.

In addition, a stopper is typically provided at an end of the housing of the busway 100 for being connected to the busway connector 200, the stopper covers the end of the housing of the busway 100 and includes a plurality of guiding grooves and a plurality of positioning grooves. Each of the guiding grooves penetrates two end surfaces of the stopper (a first end surface facing the housing of the busway 100 and a second end surface facing away from the housing of the busway 100). Each of the plurality of conductors 40 of the busway is electrically connected to a conductive bar of the busway connector 200 after passing through a corresponding guiding groove. Given the installation of the stop, bottoms of the plurality of guiding grooves are typically open, which results in poor sealing of the busway 100.

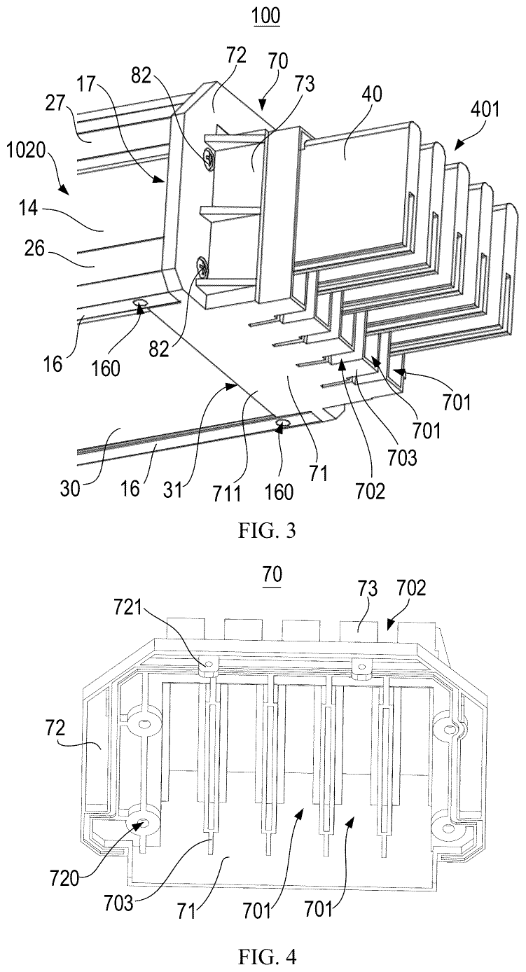

In order to solve the problem, embodiments of the present disclosure further provide a busway 100 that has a good sealing property and can better prevent water or other foreign matters from entering the interior of the busway 100. The principle of the busway 100 will be described below in conjunction with FIGS. 3 to 8.

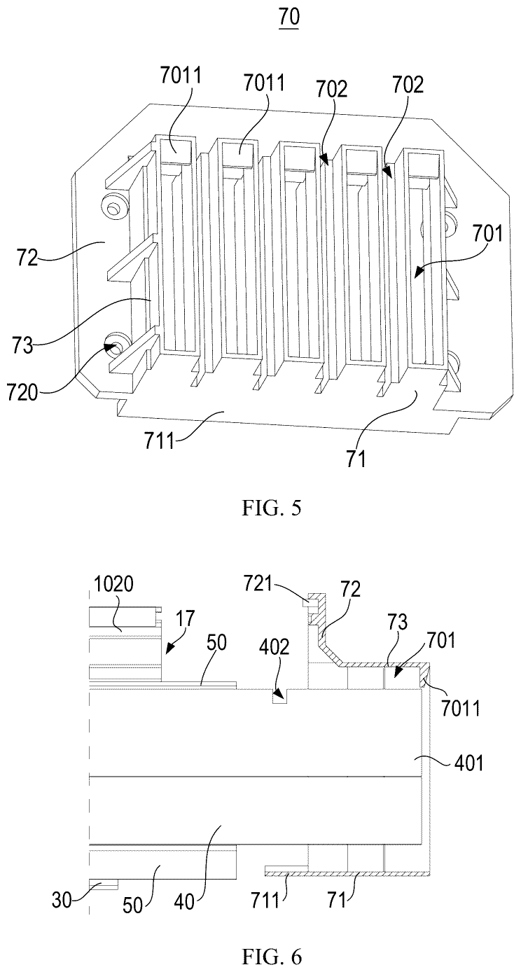

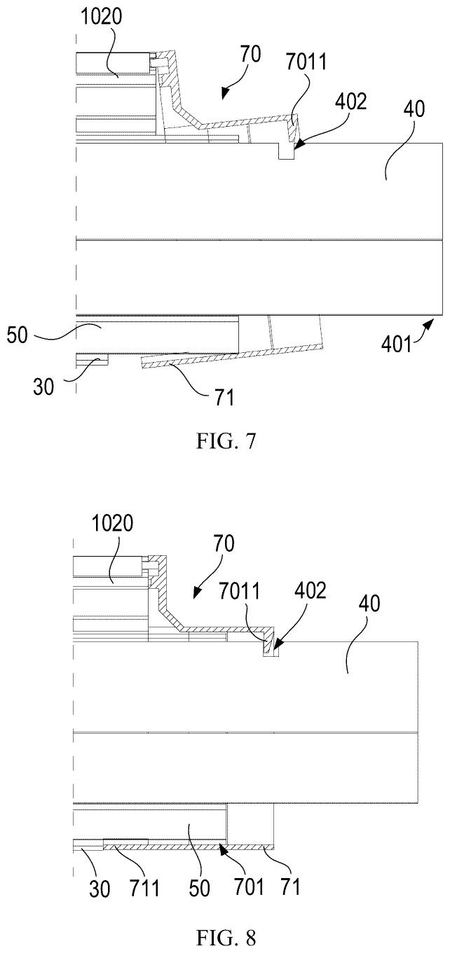

FIG. 3 shows a perspective view of busway 100. FIGS. 4 and 5 show perspective views of a stoper 70 of the busway 100 in FIG. 3 from different viewpoints. FIGS. 6 to 8 show the installation process of the stoper 70 of the busway 100 in FIG. 3.

Referring to FIG. 3, busway 100 includes a housing 1020, an enclosure 30, a plurality of conductors 40, and a stoper 70. In the case of no conflict, the structure of the busway 100 may refer to the above description of the structure of the busway 100 shown in FIG. 1 and FIG. 2, which is not described herein again.

In some embodiments, the housing 1020 of the busway 100 includes a first end 17 and a second end, and the first end 17 and the second end are two ends of the housing 1020 in an extending direction thereof. For ease of description, the end structure of the busway 100 is described herein by taking the first end 17 of the housing 1020 as an example. In some embodiments, the second end of the housing 1020 may have an end structure similar to that of the first end of the housing 17.

As described above, in some embodiments, the enclosure plate 30 is detachably connected to the engaging portions 16 on both sides of the bottom of the housing 1020, so that the enclosure plate 30 is disposed at the bottom of the housing 1020. The enclosure plate 30 is configured to shield the plurality of openings 120 of the first bottom plate 12 and the insulating members 50 extending from at least portion of the openings 120. A first end 31 of the enclosure plate 30 corresponds to the first end 17 of the housing 1020 of the busway, and a second end of the enclosure plate 30 extends toward the second end of the housing 1020 of the busway.

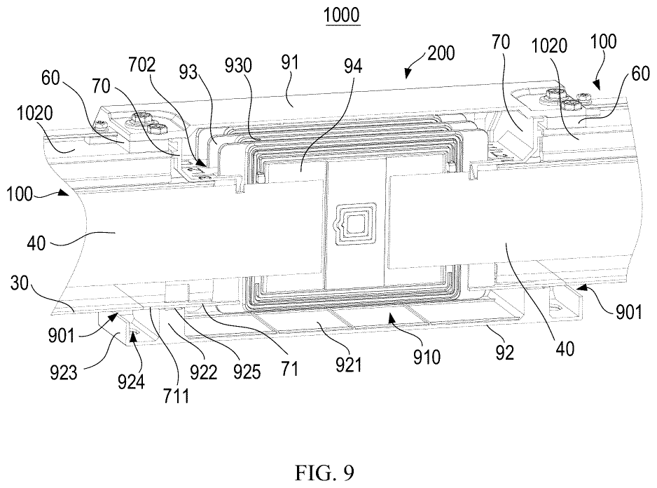

The stoper 70 covers the first end 17 of the housing 1020 of the busway. The stopper 70 is made of an insulating material. The stopper 70 includes a plurality of guiding grooves 701 through which the first ends 401 of the plurality of conductors 40 pass. A positioning groove 702 is formed on a wall body 703 between each two adjacent guiding grooves 701, and the positioning groove 702 is adapted to be engaged with an interphase partition 93 of the busway connector 200 (see FIG. 9). The stopper 70 includes a second bottom plate 7 1 which closes bottoms of the plurality of guiding grooves 701, and the second bottom plate 71 abuts against the first end 31 of the enclosure plate 30.

In the busway 100 of the embodiments of the present disclosure, the second bottom plate 71 closes the bottoms of the plurality of guiding grooves 701 and the second bottom plate 71 abuts against the first end 31 of the enclosure plate 30, so that each of the guiding groove 701 is a circumferentially closed groove and no large gap is formed between the enclosure plate 30 and the stopper 70. In this way, on the one hand, the sealing performance of the busway 100 can be effectively improved, and water or other foreign matters can be prevented from easily entering the interior of the busway 100; on the other hand, the movement of an electric arc generated between any two conductors 40 can be constrained to pass through the wall body 703, and the electric arc is split and thus extinguished when passing through the wall body 703, so that safety hazards caused by conduction of the electric arc in different busways 100 can be effectively avoided.

Referring to FIGS. 3 to 5, in some embodiments, the stopper 70 includes an end cap portion 72 and a protrusion portion 73. The end cap portion 72 is provided with a plurality of holes 720, and a plurality of second fasteners 82 pass through the plurality of holes 720 to be connected to corresponding holes (not labeled in either FIG. 1 or FIG. 2) of the first end 17 of the housing 1020, so that the stopper 70 covers the first end 17 of the housing 1020. An extending direction of the plurality of second fasteners 82 is parallel to an extending direction of the plurality of guiding grooves 701. The protrusion portion 73 extends from the end cap 72 in a direction away from the housing 1020 of the busway. The plurality of guiding grooves 701 penetrate through the end cap portion 72 and the protrusion portion 73, and each of the plurality of guiding grooves 701 is a circumferentially closed groove. The protrusion portion 73, on one hand, enables each of the guiding groove 701 to have a sufficient extension length, and on the other hand, are configured to provide a plurality of positioning grooves 702. The second bottom plate 71 is located at bottoms of the end cap portion 72 and the protrusion portion 73. Of course, in some alternative embodiments, the stopper 70 may have other implementations and is not limited to the above examples.

As described above, in some embodiments, insulating members 50 are provided in the three mounting cavities 101 and the mounting cavity 102 for accommodating the current-carrying conductors, and each of the insulating member 50 is configured to insulate a corresponding current-carrying conductor from the housing 1020. In some embodiments, the insulating members 50 extend from the first end 17 of the housing 1020 of the busway and are inserted into the corresponding guiding grooves 701, and wall bodies of the guiding grooves 701 can be configured to limit the position of each of the insulating member 50, avoiding movement of each of the insulating member 50 relative to the housing 1020.

Referring to FIG. 4 and FIG. 6 to FIG. 8, in some embodiments, a top of each conductor 40 is provided with an engaging groove 402, a wall body of each guiding groove 701 is provided with an engaging protrusion 7011 configured to be engaged with the engaging groove 402 to limit movement of each conductor 40 relative to the housing 1020. Of course, in some alternative embodiments, the movement of each conductor 40 relative to the housing 1020 may also be limited by other suitable structures.

In some embodiments, a top of the end cap portion 72 is provided with a connecting arm 721, an extending direction of the connecting arm 721 is parallel to an extending direction of the plurality of guiding grooves 701, and the connecting arm 721 is connected to the housing 1020 of the busway through a third fastener (not shown in the figure). An extension direction of the third fastener is perpendicular to the extension direction of the plurality of guiding grooves 701. In some embodiments, the connecting arm 721 is indirectly connected to the housing 1020, for example, by connecting a third fastener to the connecting plate 60. The end cap portion 72 is connected to the housing 1020 by a second fastener and a third fastener whose extending directions are perpendicular to each other, so that the connection between the end cap portion 72 and the housing 1020 is more reliable.

Referring to the installation process of the stopper 70 shown in FIG. 6 to FIG. 8, the stopper 70 is allowed to approach the first end 17 of the housing 1020 in a tilted posture by reasonably setting the sizes of the engaging grooves 402 and each of the guiding grooves 701. When the engaging protrusions 7011 are engaged with the engaging grooves 402, the posture of the stopper 70 is returned to the correct and may cover the first end 17 of the housing 1020.

It should be noted that, in some alternative embodiments, the housing of the busway 100 configured with the stopper 70 may have other variations and is not limited to the housing structures of the busways 100 shown in FIG. 1 and FIG. 2, and the stopper 70 is suitable for any busway 100 where a plurality of openings 120 is provide on the first bottom plate and the plurality of openings 120 is shielded by the enclosure plate 30.

Embodiments of the present disclosure further provide a busway assembly 1000, the busway assembly 1000 includes the busway connector 200 and two busways 100 located on left and right sides of the busway connector 200, the two busways 100 are electrically connected to each other through the busway connector 200, and a structure of at least one of the two busways 100 is similar to that of the busway 100 shown in FIGS. 3 to 8. Referring to FIG. 9, in some embodiments, structures of both busways 100 on the left and right sides of the busway connector 200 are each similar to the busway 100 shown in FIGS. 3-8. For ease of description, the connection between the busway connector 200 and the left busway 100 is primarily described below, and the connection between the busway connector 200 and the right busway 100 is not described again.

Referring to FIG. 2 and FIG. 9, in some embodiments, the busway connector 200 includes an upper cover plate 91, a lower cover plate 92, and a plurality of interphase partitions 93. When the busway assembly 1000 is in an actual use state, the upper cover plate 91 is located above the lower cover plate 92. Referring to FIG. 9, the upper cover plate 91 and the lower cover plate 92 are assembled together to define an internal chamber 910 and left and right openings 901 communicating with the internal chamber 910. A first end of the left busway 100 extends into the interior chamber 910 through the left opening 901. A plurality of interphase partitions 93 are located in the internal chamber 910 and each of the interphase partition 93 is provided with a conductive bar 94. An accommodating space 930 is formed between each two adjacent interphase partitions 93, and the accommodating space 930 is configured to accommodate a corresponding conductor of the busway 100. The two conductors 40 of the left and right busways 100 extending into the same accommodating space 930 are electrically connected to each other through the conductive bar 94.

The upper cover plate 91 and the lower cover plate 92 may be made of a metal material. Referring to FIG. 3 and FIG. 9, in some embodiments, the first end 17 of the housing 1020 of the busway protrudes a predetermined distance relative to the first end 31 of the enclosure plate 30. The second bottom plate 71 includes an extension portion 711 extending to the bottom of the housing 1020 of the busway to abut against the enclosure plate 30. The lower cover plate 92 includes a bottom wall 921 located below the second bottom plate 71, and the bottom wall 921 of the lower cover plate 92 is provided with an upward-protruding bump 922, and the bump 922 abuts against the second bottom plate 71. In this way, water can be prevented from flowing into the internal chamber 910 along the enclosure plate 30 and the second bottom plate 71. In addition, by abutting the bump 922 against the second bottom plate 71 made of the insulating material, and deviating the abutting position of the second bottom plate 71 against the enclosure plate 30 from the bump 922, it helps to increase the creepage distance/electrical gap between each of the conductors 40 and the bump 922, and to avoid the creepage distance/electrical gap between the bump 922 and each of the conductors 40 from meeting the requirements.

With continued reference to FIG. 9, in some embodiments, a sealing gasket 925 is provided between the bump 922 and the second bottom plate 71 to further improve sealing performance between the bump 922 and the second bottom plate 71. In some embodiments, the bump 922 is provided with a groove for positioning the sealing gasket 925.

With continued reference to FIG. 9, in some embodiments, the bottom wall 921 of the lower cover plate 92 forms an upward-extending flange 923 at the opening 901, the bottom wall 921 of the lower cover plate 93 is further provided with a through hole 924 located between the flange 923 and the bump 922. In this way, the flange 923 can prevent large foreign matters from approaching the bump 922, water flowing along the enclosure plate 30 and the second bottom plate 71 is stopped by the bump 922 and flows downward, and can be discharged through the through hole 924.

Embodiments of the present disclosure have been described above, and the above description is illustrative, not exhaustive, and is not limited to the disclosed embodiments. Many modifications and variations will be apparent to those of ordinary skill in the art without departing from the scope and spirit of the illustrated embodiments. The selection of terms as used herein is intended to best explain the principles of the embodiments, the practical application or technical improvements to the market, or to enable others of ordinary skill in the art to understand the embodiments disclosed herein.

1. A housing of a busway, comprising:
a first housing comprising:
a first top plate and a first bottom plate opposite to each other;
a first side plate and a second side plate opposite to each other; and
a plurality of partitions respectively connected to the first top plate and the first bottom plate and spaced apart in a direction from the first side plate to the second side plate, the plurality of partitions dividing an inner cavity of the first housing into a plurality of mounting cavities for accommodating a plurality of conductors,
wherein the first bottom plate is provided with a plurality of openings, and the plurality of mounting cavities are communicated with the exterior through the plurality of openings; and
a second housing located outside the first housing and at least comprising a second top plate and a third side plate connected to each other, the second top plate being connected to the first top plate through at least one first rib plate, and the third side plate being connected to one of the first side plate and the second side plate through at least one second rib plate.

2. The housing according to claim 1, wherein
the third side plate is connected to the first side plate through the at least one second rib plate, and
wherein a junction of the first top plate and the first side plate is connected to a junction of the second top plate and the third side plate through a third rib plate.

3. The housing according to claim 1, wherein the plurality of mounting cavities comprise three phase line mounting cavities and one neutral line mounting cavity sequentially arranged in the direction from the first side plate to the second side plate, and the third side plate is connected to the first side plate through the at least one second rib plate.

4. The housing according to claim 3, wherein
the second top plate is connected to the first top plate through a plurality of first rib plates spaced apart from each other; and/or
the third side plate is connected to the first side plate through a plurality of second rib plates spaced apart from each other.

5. The housing according to claim 3, wherein
the plurality of mounting cavities further comprises a ground wire mounting cavity located on a side of the neutral line mounting cavity facing away from the three phase line mounting cavities; and/or
the first bottom plate extends from the first side plate to the third side plate, and an upper edge of the second side plate extends upward to be connected to a side edge of the second top plate close to the second side plate.

6. The housing according to claim 1, wherein the housing is provided with a mounting hole configured to be connected to a busway connector through a first fastener.

7. The housing according to claim 6, wherein two sides of a bottom of the housing are respectively provided with an engaging portion, and the engaging portion protrudes downward relative to the first bottom plate and adapted to be detachably connected to an enclosure plate, and
wherein a bottom surface of the engaging portion is provided with the mounting hole.

8. The housing according to claim 1, wherein the third side plate is adjacent to the first side plate,
a first support platform is formed at a bottom of the third side plate, and a second support platform is formed at a bottom of the second side plate; and/or
the second side plate and the third side plate are each provided with a third bent plate, a first accommodating groove is formed between the second side plate and a corresponding third bent plate, and a second accommodating groove is formed between the third side plate and a corresponding third bent plate.

9. The housing according to claim 1, wherein the housing is an aluminum housing.

10. A busway, comprising the housing of the busway according to claim 1.

11. The busway according to claim 10, further comprising:
an enclosure plate disposed at a bottom of the housing of the busway to shield the plurality of openings, a first end of the enclosure plate corresponding to a first end of the housing of the busway;
a plurality of conductors disposed in the plurality of mounting cavities;
a stopper covering the first end of the housing of the busway, and comprising a plurality of guiding grooves through which the first ends of the plurality of conductors pass, a positioning groove being formed on a wall body between each two adjacent guiding grooves, the positioning groove being adapted to be engaged with an interphase partition of a busway connector, and
the stopper comprising a second bottom plate closing bottoms of the plurality of guiding grooves, and the second bottom plate abutting against the first end of the enclosure plate.

12. The busway according to claim 11, wherein
a first end of the housing of the busway protrudes a predetermined distance relative to the first end of the enclosure plate,
the second bottom plate comprises an extension portion extending to the bottom of the housing of the busway to abut against the enclosure plate.

13. The busway according to claim 11, wherein the stopper comprises:
an end cap portion connected to the first end of the housing of the busway by a second fastener, an extension direction of the second fastener being parallel to an extension direction of the plurality of guiding grooves; and
a protrusion portion extending from the end cap portion in a direction away from the housing of the busway, and
wherein the second bottom plate is located at bottoms of the end cap portion and the protrusion portion, the plurality of guiding grooves penetrate through the end cap portion and the protrusion portion, each of the plurality of guiding grooves is a circumferentially closed groove, and the positioning groove is located on the protrusion portion.

14. The busway according to claim 11, wherein
at least a portion of the plurality of mounting cavities is provided with an insulating member configured to insulate a corresponding conductor from the housing of the busway, and
the insulating member extends from the first end of the housing of the busway and is inserted into a corresponding guiding groove.

15. The busway according to claim 11, wherein
a top of each of the plurality of conductors is provided with an engaging groove, and a wall body of each of the plurality of guiding grooves is provided with an engaging protrusion configured to be engaged with the engaging groove; and/or
a top of the end cap portion is provided with a connecting arm, an extending direction of the connecting arm is parallel to an extending direction of the plurality of guiding grooves, the connecting arm is connected to the housing of the busway through a third fastener, and an extending direction of the third fastener is perpendicular to the extending direction of the plurality of guiding grooves.

16. A busway assembly, comprising:
the busway according to claim 11; and
a busway connector, comprising:
an upper cover plate and a lower cover plate assembled together, the upper cover plate and the lower cover plate defining an internal chamber and an opening communicating with the internal chamber, a first end of the busway extending into the internal chamber through the opening; and
a plurality of interphase partitions located in the internal chamber, each of the interphase partitions being provided with a conductive bar, wherein an accommodating space is formed between each two adjacent interphase partitions, and the accommodating space is configured to accommodate a corresponding conductor of the busway.

17. The busway assembly according to claim 16, wherein
a first end of the housing of the busway protrudes a predetermined distance relative to the first end of the enclosure plate,
the second bottom plate comprises an extension portion extending to the bottom of the housing of the busway to abut against the enclosure plate.

18. The busway assembly according to claim 17, wherein the lower cover plate comprises a bottom wall located below the second bottom plate, and the bottom wall of the lower cover plate is provided with a upward-protruding bump, and the bump abuts against the second bottom plate.

19. The busway assembly according to claim 18, wherein a sealing gasket is provided between the bump and the second bottom plate.

20. The busway assembly according to claim 18, wherein the bottom wall of the lower cover plate forms an upward-extending flange at the opening, and the bottom wall of the lower cover plate is further provided with a through hole located between the flange and the bump.
